(19) United States
(12) Patent Application Publication
(10) Pub. No.: US 2024/0421543 A1
(43) Pub. Date: Dec. 19, 2024

(54) PLUG CONNECTOR PART WITH A SHIELD SUPPORT

(71) Applicant: Phoenix Contact GmbH & Co. KG, Blomberg (DE)

(72) Inventor: Ralf GESKE, Schieder-Schwalenberg (DE)

(21) Appl. No.: 18/695,008

(22) PCT Filed: Sep. 13, 2022
(86) PCT No.: PCT/EP2022/075395

§ 371 Date: Mar. 25, 2024

(30) Foreign Application Priority Data
Sep. 27, 2021 (LU) LU500693

(51) Int. Cl. H01R 13/6597; H01R 4/30; H01R 12/71; H01R 13/514; H01R 13/6591; H01R 13/6592

(52) U.S. Cl. CPC H01R 13/6597; H01R 13/514; H01R 13/65912; H01R 13/6592; H01R 4/30; H01R 12/712

(57) ABSTRACT

A plug connector part for electrical connection to a mating plug connector part includes: a housing having a plurality of plug-in portions, on each of which a contact for electrically contacting a contact of a relevant mating plug-in portion of the mating plug connector part is arranged; a shield connection electrically connected to the contact of one of the plug-in portions; and a shield support having a bearing portion for a shield of a cable to be connected. The shield support is electrically connectable to the shield connection via a connecting element.

### CROSS-REFERENCE TO PRIOR APPLICATIONS

This application is a U.S. National Phase application under 35 U.S.C. § 371 of International Application No. PCT/EP2022/075395, filed on Sep. 13, 2022, and claims benefit to Luxembourg Patent Application No. LU 500693, filed on Sep. 27, 2021. The International Application was published in German on Mar. 30, 2023 as WO/2023/046532 under PCT Article 21 (2).

### FIELD

The invention relates to a plug connector part for electrical connection to a mating plug connector part, and a plug connection having such a plug connector part.

### BACKGROUND

In the case of plug connections having a plug connector part and a corresponding mating plug connector part, the difficulty often arises that it is only after cables have been connected and, if needed, an electrical device connected thereto has been started up that it becomes apparent that it is necessary to connect a shield of a cable connected to the plug connector part to the side of the mating plug connector part via the plug connection. For example, in the context of an approval test, it is found that excessive interference radiation is present, or the like. In practice, however, the problem then often arises that the already-mounted, and frequently soldered, plug connection has to be replaced, which can involve a disproportionately increased amount of effort.

DE 10 2019 100 219 A1 describes a plug connection in which a plug housing is arranged on a base plate which is used as shielding of the plug connector. In this plug connection, although the shielding has a dual use, the known plug connection can be mounted only with the shielding, and not without. This results in a disproportionately high assembly effort in many applications.

### SUMMARY

In an embodiment, the present invention provides a plug connector part for electrical connection to a mating plug connector part, the plug connector part comprising: a housing comprising a plurality of plug-in portions, on each of which a contact configured to electrically contact a contact of a relevant mating plug-in portion of the mating plug connector part is arranged: a shield connection electrically connected to the contact of one of the plug-in portions; and a shield support having a bearing portion for a shield of a cable to be connected, wherein the shield support is electrically connectable to the shield connection via a connecting element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a plug connection with a plug connector part which is connected to a matching mating plug connector part, together with a cable connected to the plug connector part and a circuit board on which the mating plug connector part is mounted:

FIGS. 2 and 3 are perspective views of the plug connector part:

FIGS. 4 to 6 are plan views of the plug connection:

FIGS. 7 and 8 are sectional views of the plug connection, partially cut-away along the sectional plane A-A: shown in FIG. 6;

FIG. 9 is a view of a housing of the plug connector part:

FIG. 10 is a view of the mating plug connector part together with the circuit board:

FIG. 11 is a view of a current path from a shield support of the plug connector part to a circuit board mounted on the mating plug connector part; and

FIG. 12 and FIG. 13 are views of the shield support.

### DETAILED DESCRIPTION

In an embodiment, the present invention provides an improved plug connector part.

Accordingly, a plug connector part for electrical connection to a mating plug connector part is provided, which comprises a housing, a shield connection, and a shield support. The housing comprises a plurality of plug-in portions, on (in particular in) each of which a contact for electrically contacting a contact of a relevant mating plug-in portion of the mating plug connector part is arranged. The shield connection is electrically connected to the contact of one of the plug-in portions. The shield support has a bearing portion for a shield of a cable to be attached, wherein the shield support can be, and in the mounted state is, electrically connected to the shield connection via a connecting element.

This is based on the idea of conducting the potential of the shield not separately, but via one of the plug-in portions of the plug connector part to the mating plug connector part. It can thus be achieved that the transfer of the shielding potential is always possible, even subsequently. For this purpose, before or even after the plug connector part is connected, the shield support is mounted and connected. The shield support then connects the shield of the cable to the corresponding contact. In this case, it is also possible to not mount and connect the shield support, or to do so only at a later point in time, without the plug connector part or the mating plug connector part having to be replaced for this purpose. A plug connection which can be used in a particularly versatile and needs-based manner, and is thus improved, is therefore made possible by the plug connector part.

In one embodiment, the shield connection is arranged in the interior of the housing. In this way, it is protected, specifically in the event that the shield support is not connected.

The housing can have an opening (e.g., a hole) through which the connecting element can be, and in the mounted state is, inserted, and through which the connecting element can be, and in the mounted state is, electrically connected to the shield connection. In this way, a protected and at the same time simple design is made possible.

Optionally, the shield support can be, and in the mounted state is, fastened to the housing by means of the connecting element. The connecting element thus has a dual function and provides both electrical contacting and a mechanical holder. The connecting element is detachable from the housing in order to separate the shield support. The connecting element can be fastenable or fastened, for example, directly to the shield connection. The shield connection is fastened, for example, independently of the shield support in the housing.

The connecting element can be designed in the form of a screw which, for example, can be, and in the mounted state is, screwed to the shield connection. This makes a particularly secure connection possible.

The housing can comprise a plurality of connections for connecting in each case one conductor of the cable to be connected. In this case, the plug connector part can comprise at least or exactly one more plug-in portion than connections. Therefore, in the case of a total number of n connections of the plug connector part, for conductors of the cable which are electrically separated from one another, the plug connector part can comprise a total number of n+1 plug-in portions having contacts which are electrically separated from one another.

In the mounted state, and with respect to the insertion direction in which the plug connector part can be (or is) plugged onto the mating plug connector part, the shield support can be arranged spaced apart from the plug-in portions. This makes it easier for the shield support to be mounted on or removed from the housing of the plug connector part, even in the state plugged onto the mating plug connector part. For example, the shield support does not overlap with the mating plug connector part when the plug connector part is plugged thereon. In general, and in particular in this arrangement, it can be provided that the shield support does not touch the mating plug connector part when the plug connector part is plugged thereon.

In one embodiment, in the mounted state, the shield support is arranged behind the plug-in portions with respect to the insertion direction. It can thus be arranged in the rear region of the plug connector part, so that the shield support can be mounted on or removed from the housing of the plug connector part even in the state plugged onto the mating plug connector part.

Optionally, some or all of the plug-in portions are arranged in a row, in particular at least two or at least three plug-in portions which include the plug-in portion which comprises the contact that is electrically connected to the shield connection. Optionally, the plug-in portions and/or the contacts thereof are designed to be identical or substantially identical to one another.

A bearing portion of the shield support can extend at least over a portion, in particular over the predominant portion of a width of the housing. The width extends, for example, perpendicularly to the insertion direction. An effective shielding of the housing can thus be achieved. The shield support is designed to be planar, for example.

Optionally, the shield support has a tab. The tab can be brought into engagement with, and in the mounted state engages with, a projection of the housing. As a result, unintentional rotation of the shield support relative to the housing can be prevented.

The contact that is electrically connected to the shield connection is designed, for example, in the form of a contact fork. In this case, it can be provided that a contact of a mating plug-in portion of the mating plug connector part can be inserted into the contact fork in an electrically contacting manner. The contact of the mating plug connector part is, for example, a contact pin or contact blade.

According to one aspect, a plug connection is provided which comprises a plug connector part according to any embodiment described herein, and a mating plug connector part which can be (or is) connected thereto. In this case, the mating plug connector part can have a contact which is used as a shield contact, for example, and which, in the state connected to the plug connector part, is electrically connected to the shield connection of the plug connector part.

The contact used as a shield contact is, for example, connected via a pin to a circuit board. It is thus possible for the potential of the shield to be conducted to the circuit board in a particularly simple manner.

The shield support can in particular be mountable on the plug connector part when the plug connector part is (already) connected to the mating plug connector part.

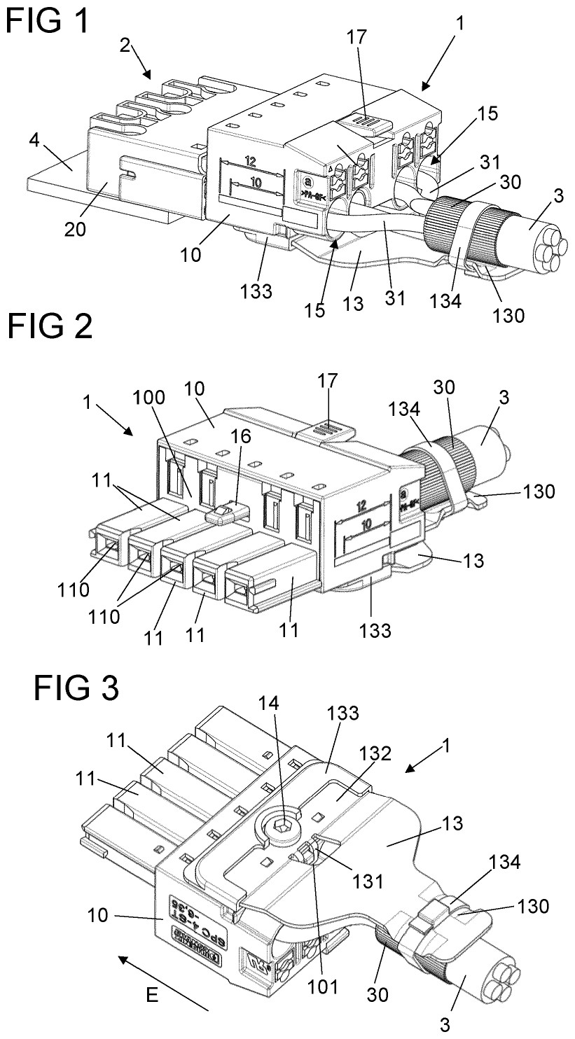

FIG. 1 shows a plug connection made of a plug connector part 1 and a corresponding mating plug connector part 2. A cable 3 is connected to the plug connector part 1. The mating plug connector part 2 is mounted on a circuit board 4. For example, the mating plug connector part 2 is arranged at an opening in a housing wall.

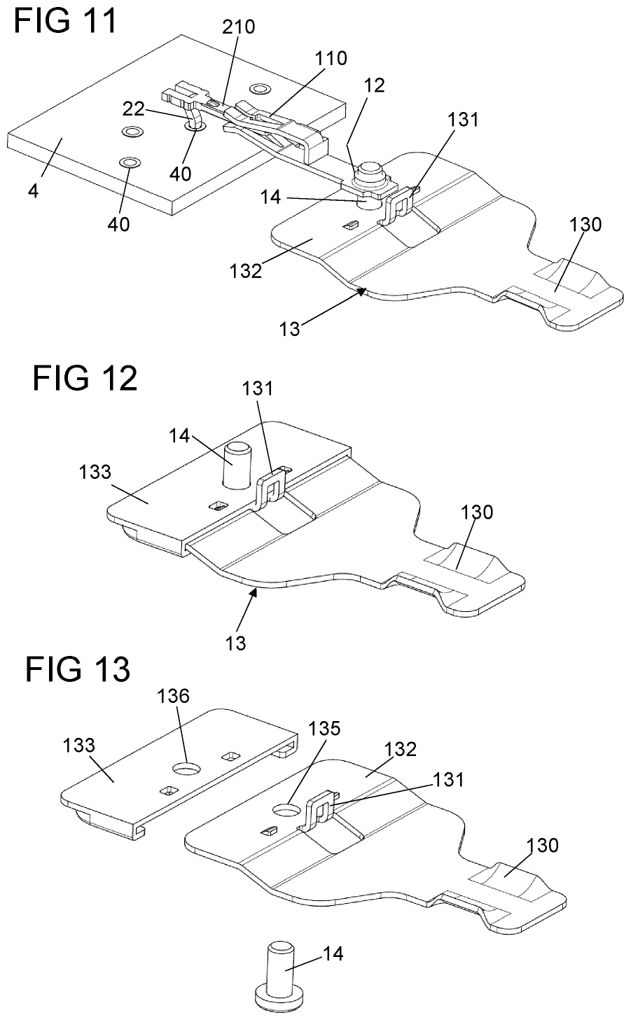

The circuit board 4 has contact points 40 (see, for example, FIG. 11), in the present case at each opening, to which pins 22 of the mating plug connector part 2 are connected, and in the example shown, inserted therein and soldered thereto.

The cable 3 comprises a plurality of conductors 31 which are electrically insulated from one another and are each electrically connected to one of a plurality of (in this case: four) connections 15 of the plug connector part 1. An optional release 18 is provided in each case, wherein the relevant conductor 31 can be removed again by actuating the release. Furthermore, the cable 3 comprises a shield 30, occasionally also referred to as shielding. The shield 30 is electrically conductive. The shield 30 consists, for example, of a foil or a mesh. The shield 30 encloses the conductors 31.

In the present case, the shield 30 is enclosed by an insulating sheath. The insulating sheath is removed at one end of the cable 3, so that the shield 30 is exposed. In this case it is folded back, for example, so that it rests on the outside of the insulating sheath. At this point (or generally at any point at which the shield 30 is exposed) the shield 30 rests against a bearing portion 130 of a shield support 13 and electrically contacts it. A clamp 134 secures this position and electrical contacting.

The shield support 13 is formed by a planar, electrically conductive piece of material. In the present case, the shield support 13 is formed by a metal sheet. The shield support can also be described as a shield sheet. The metal sheet of the shield support 13 is a stamped and bent part.

FIGS. 2 and 3 show the plug connector part 1 without the mating plug connector part 2. It can be seen in particular that the plug connector part 1 comprises a housing 10 having a plurality of plug-in portions 11 (in this case: five), on each of which a contact 110 for electrically contacting a contact 210 of a relevant mating plug-in portion 21 of the mating plug connector part 2 (see, for example, FIG. 10) is arranged.

As can be seen, the plug connector part 1 comprises one more plug-in portion 11 than connections 15. The mating plug connector part 2 comprises the same number of mating plug-in portions 21 as the plug connector part 1 comprises plug-in portions 11. The plug-in portions 11 are all arranged in a row, specifically along a straight line.

The housing 10 is designed in multiple parts, but can alternatively also be designed in one part. In the present case, the housing 10 is made of an insulating material.

As illustrated in particular by FIG. 3, a shielding portion 132 of the shield support 13 rests flush against one side of the housing 10 of the plug connector part 1. In this case, the shielding portion extends over approximately the entire width of the housing 10, perpendicularly to the insertion direction E in which the plug connector part 1 can be plugged into the mating plug connector part 2. To extend its path, the shielding portion 132 is accommodated in a shield shoe 133 made of an insulating material, e.g., a plastics material. The shielding portion 132 is wider than the bearing portion 130. A step is formed between the shielding portion 132 and the bearing portion 130. Two sides on the bearing portion 130 are bent, so that the cable 3 can be securely held and the shield 30 can be contacted over a large area.

The shield support 13 is fastened to the housing 10 by a connecting element 14, which in the example shown is a screw. The connecting element 14 is a component which is formed separately from the shield support 13 and from the shield connection 12. The connecting element 14 is in contact with the shielding portion 132 of the shield support 13. In the mounted state, a tab 131 of the shield support 13 is in engagement with a projection 101 on the housing 10. A rotation of the shield support 13 relative to the housing 10 can thus be prevented.

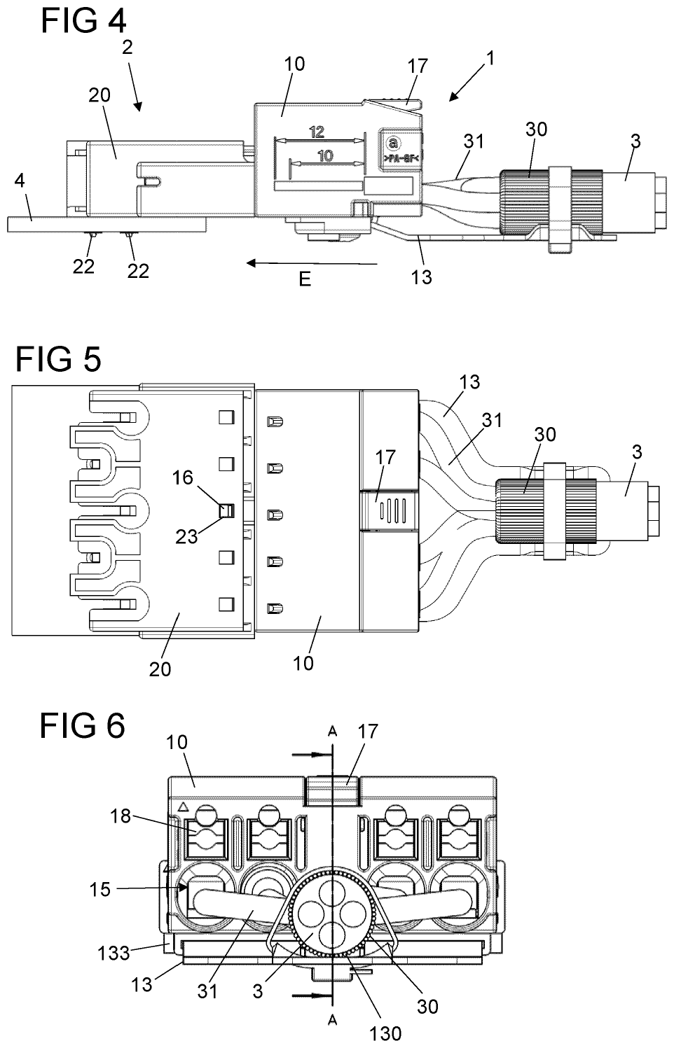

As shown, for example, in FIGS. 3 and 4, the shield support 13 rests on the outside of the housing 10.

From FIGS. 4 to 8, it can be seen that the shield support 13 extends from the housing 10 of the plug connector part 1 in a direction away from the mating plug connector part 2. It can also be seen that the shield support 13 is spaced apart from the mating plug connector part 2 and does not cover or overlap with it. Viewed in the insertion direction, the shield support 13 is arranged behind the plug-in portions 11 (and the plugged-on mating plug connector part 2).

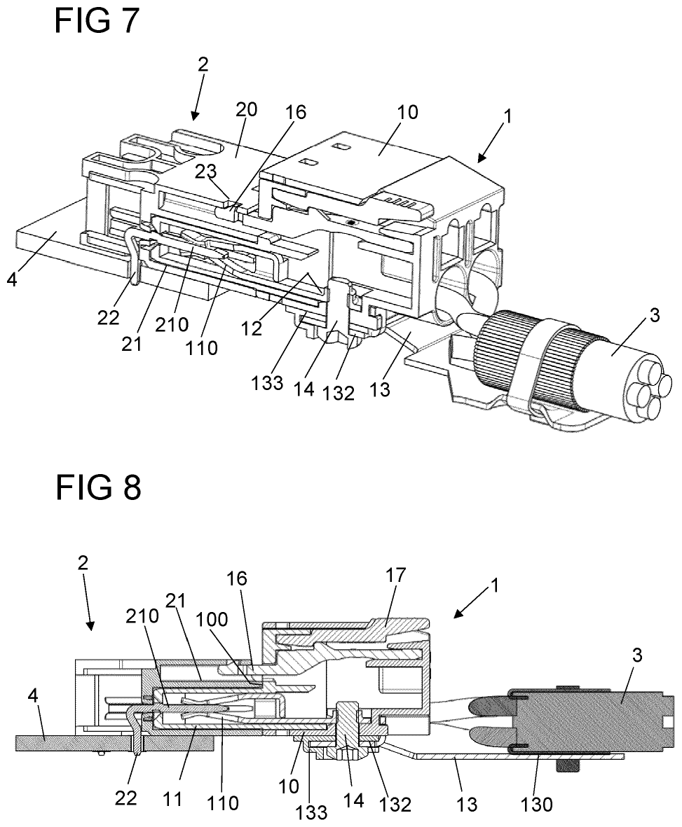

It can be seen in particular from FIGS. 7, 8 and 11, that the bearing portion 130 of the shield support 13 is electrically connected to the contact 110 by one of the plug-in portions of the plug connector part 1 via the connecting element 14, in order to conduct the electrical potential of the shield 30 from the cable 3 via the plug connector part 1 and the mating plug connector part 2 to the circuit board 40. For this purpose, the connecting element 14 is made of an electrically conductive material. A shield connection 12, which is electrically connected to this contact 110, is arranged in the interior of the housing 10 for this purpose.

The shield connection 12 has a screw opening 120 having an internal thread into which the connecting element 14 is screwed. The shield connection 12 also has a connection portion which connects the screw opening 120 to the corresponding contact 110, and in the present case is formed in one piece therewith. The contact 110 and the shield connection 12 are arranged completely in the housing 10.

The connecting element 14 thus establishes both a mechanical and an electrical connection. The contact 110 that is electrically connected to the shield connection 12 is arranged in the row of the plug-in portions 11 on the central plug-in portion.

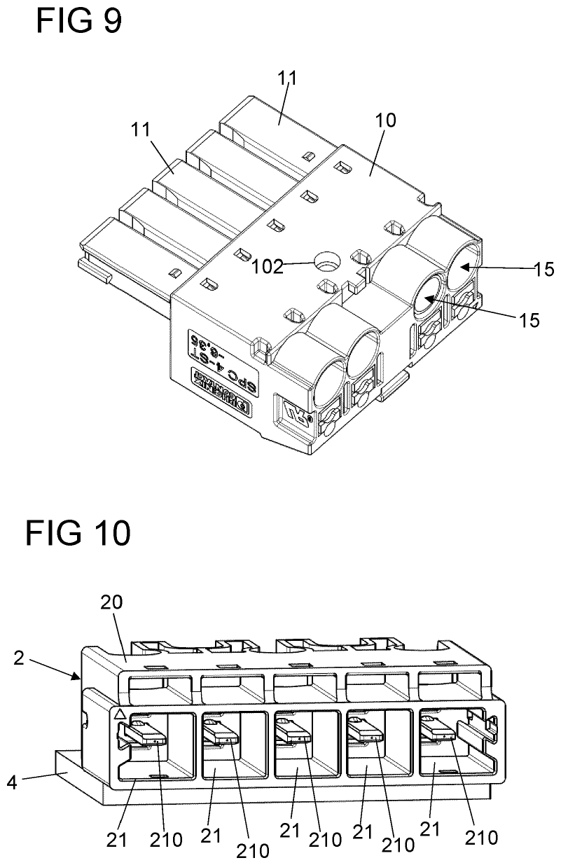

The connecting element 14 extends through an opening 135 in the bearing portion 132, an (optional) opening in the (optional) shield shoe 133 (see, for example, FIGS. 12 and 13), an opening 102 in the housing (see FIGS. 7 to 9) and into the shield connection 12. For this purpose, the shield connection 12 comprises an internal thread into which a screw can be screwed.

In the present case, the contact 110 is a contact fork into which a pin-shaped contact 210 of a mating plug-in portion 21 of the mating plug connector part 2 can be inserted in an electrically contacting manner, see, for example, FIG. 10.

From FIG. 8, for example, it can be seen that the shield support 13 is arranged behind and spaced apart from the plug-in portions 11 with respect to the insertion direction E.

When inserted against one another, a stop surface 100 of the plug connector part 1 abuts a stop surface of the mating plug connector part 2.

FIG. 10 shows the mating plug connector part 2 in detail. It can be seen in particular that the mating plug connector part 2 has a housing 20 which forms the plurality of mating plug-in portions 21. A contact 210 is arranged in each of the mating plug portions 21. The contacts 210 are each designed to be identical to one another. Furthermore, the contacts 110 of the plug connector part 1 are also designed to be identical to one another.

In particular, FIGS. 2, 7 and 8 also show a locking mechanism of the plug connection. The plug connector part 1 has a locking element 16 that can be moved relative to the housing 10 by means of an actuating element 17. In the locked state, a latching lug of the locking element 16 engages into a counter locking element 23 of the mating plug connector part 2, which is designed here in the form of an opening. In order to release the lock, the actuating element 17 can be pressed, as a result of which the latching lug of the locking element 16 is moved out of the counter locking element 23 in the form of the opening, so that the plug connector part 1 and the mating plug connector part 2 can be separated from one another.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Plug connector part
10 Housing
100 Stop surface
101 Projection
102 Opening
11 Plug-in portion
110 Contact
12 Shield connection
120 Screw opening
13 Shield support
130 Bearing portion
131 Tab
132 Shielding portion
133 Shield shoe
134 Clamp
135 Opening
136 Opening
14 Connecting element
15 Connection
16 Locking element
17 Actuating element
18 Release
2 Mating plug connector part
20 Housing
21 Mating plug-in portion
210 Contact
22 Pin
23 Counter locking element
3 Cable
30 Shield
31 Conductor
4 Circuit board
40 Contact point
E Insertion direction

1. A plug connector part for electrical connection to a mating plug connector part, the plug connector part comprising:
a housing comprising a plurality of plug-in portions, on each of which a contact for configured to electrically contact a contact of a relevant mating plug-in portion of the mating plug connector part is arranged;
a shield connection electrically connected to the contact of one of the plug-in portions; and
a shield support having a bearing portion for a shield of a cable to be connected,
wherein the shield support is electrically connectable to the shield connection via a connecting element.

2. The plug connector part of claim 1, wherein the shield connection is arranged inside the housing.

3. The plug connector part of claim 1, wherein the housing has an opening through which the connecting element is electrically connectable to the shield connection.

4. The plug connector part of claim 1, wherein the shield support is fastenable to the housing by the connecting element.

5. The plug connector part of claim 1, wherein the connecting element is comprises a screw that is screwable to the shield connection.

6. The plug connector part of claim 1, wherein the housing comprises a plurality of connections for connecting in each case one conductor of the cable to be connected, one more plug-in portion being provided than connections.

7. The plug connector part of claim 1, wherein, in a mounted state, when viewed in an insertion direction in which the plug connector part is pluggable onto the mating plug connector part, the shield support is arranged spaced apart from the plug-in portions.

8. The plug connector part of claim 7, wherein, in the mounted state, the shield support is arranged behind the plug-in portions when viewed in the insertion direction.

9. The plug connector part of claim 1, wherein the plug-in portions are arranged in a row.

10. The plug connector part of claim 1, wherein a bearing portion of the shield support extends at least over a predominant portion of a width of the housing.

11. The plug connector part of one of the claim 1, wherein the shield support has a tab which configured to be brought into engagement with a projection of the housing.

12. The plug connector part of claim 1, wherein the contact, which is electrically connected to the shield connection comprises a contact fork, into which a contact of a mating plug-in portion of the mating plug connector part is insertable in an electrically contacting manner.

13. A plug connection, comprising:
the plug connector part of claim 1; and
a mating plug connector part electrically connectable thereto, the mating plug connector part having a contact comprising a shield contact and being electrically connected to the shield connection of the plug connector part in a state connected to the plug connector part.

14. The plug connection of claim 13, wherein the contact used as the shield contact is connected to a circuit board via a pin.

15. The plug connection of claim 13, wherein the shield support is mountable on the plug connector part when the plug connector part is connected to the mating plug connector part.
